(19) United States
(12) Patent Application Publication
(10) Pub. No.: US 2010/0011668 A1
(43) Pub. Date: Jan. 21, 2010

(54) MOUNTING BRACKET FOR FRAMELESS DOOR

(76) Inventors: Douglas G. Broadhead, Brampton (CA); Ed Fortin, Newmarket (CA)

Correspondence Address: MAGNA INTERNATIONAL, INC., 337 MAGNA DRIVE, AURORA, ON, L4G-7K1, CA

(21) Appl. No.: 12/523,109

(22) PCT Filed: Jan. 17, 2008
(86) PCT No.: PCT/CA2008/000102

§ 371 Date: Jul. 14, 2009

Related U.S. Application Data
(60) Provisional application No. 60/885,264, filed on Jan. 17, 2007.

(51) Int. Cl. E05F 11/38

(52) U.S. Cl. 49/348

(57) ABSTRACT

The invention is a window regulator for moving a closure panel between a first and a second position in a door for a vehicle. The window regulator includes at least one rail with a lift plate slidably mounted to the at least one rail that retains the closure panel. An adjustable mounting structure pivotally attaches the at least one rail to a surface in the door so that the closure panel is operable to pivot around a fixed instantaneous center that is displaced away from the at least one rail. In a preferred embodiment, the mounting structure includes a jackscrew mounted to one end of the rail and a four bar hinge located at the other end.

### FIELD OF THE INVENTION

The present invention relates to window regulators for automotive vehicles. More specifically, the present invention relates to a mounting bracket that adjusts the angle and position of the window glass.

### BACKGROUND OF THE INVENTION

For most vehicles, glass run channels in the door frame ensure that the window glass will align correctly with the window seals when the glass is in the raised position. However, for vehicles that use frameless doors (particularly convertibles), aligning the window glass when it is in the raised position is not so simple. Manufacturing variances require that cross-car adjustments must be made during vehicle assembly to ensure correct alignment and that the glass abuts the seals correctly. During assembly, a cross-car adjustment of 10 mm or more may be required.

Adjustments typically involve rotating the angle of the window glass by 1 or 2 degrees at the base of the glass so that the upper edge of the window glass aligns correctly. Depending on the packaging requirements of the vehicle door, the glass can be pivoted via adjusting one or both ends of the window rail (relative to the door frame or equipment module that the rails are mounted to) or by making adjustments to the lifter plate on the rail. These adjustments change the position of the window glass so that it no longer exits the door frame directly between the seals. Adjustments are preferably made as close to the beltline of the door (i.e., near the bottom window edge) as possible, as this reduces frictional drag on the lower window seals. Too much drag can damage the seals or cause poor performance in the window regulator. This problem is exacerbated when the window rails are mounted to an equipment module rather than the door frame proper. Since the module must be fully surrounded by the door's metal frame to ensure door rigidity, the adjustment screws for the rail are located well below the beltline. Thus, even minimal adjustments can cause frictional drag on the window seals. The further the adjustment mechanism is from the beltline, the greater the problem becomes.

Another difficulty with frameless windows is that the cross-car adjustment of the window glass must typically be done after the door is mounted to the vehicle to ensure correct alignment with the roof. Thus, any adjusting mechanism in the door must be easily accessible to the worker if the door is pre-assembled.

It is therefore desired to provide an adjustment mechanism for a window regulator that will provide cross-car adjustment without damaging the window seals. It is also desired to provide an adjusting mechanism that is suitable for use with rails that are mounted to an equipment module. It is further desired to provide an adjusting mechanism that can be used on a door after the door is assembled and mounted to the vehicle.

### SUMMARY OF THE INVENTION

It is an object of the present invention to provide an adjustment mechanism for a window regulator that provides cross-car adjustment while minimizing damage to the window seals. It is a further object of the invention to provide an adjustment mechanism for a window regulator that can be adjusted after the door is assembled and mounted to the vehicle. Another objective of the invention is to provide a window regulator for a frameless door that is adapted to be mounted to an equipment module within the door frame.

According to a first aspect of the invention, there is provided a window regulator for moving a closure panel between a first and a second position in a door for a vehicle. The window regulator includes at least one rail with a lift plate slidably mounted to the at least one rail that retains the closure panel. An adjustable mounting structure pivotally attaches the at least one rail to a surface in the door so that the closure panel is operable to pivot around a fixed instantaneous center that is displaced away from the at least one rail. In a preferred embodiment, the mounting structure includes a jackscrew mounted to one end of the rail that translates the end linearly and a four bar hinge located at the other end which moves the rail end in an elliptical path.

### BRIEF DESCRIPTION OF THE DRAWINGS

Preferred embodiments of the present invention will now be described, by way of example only, with reference to the attached Figures, wherein:

FIG. 1 shows a side view of a vehicle having a window regulator mounted to an equipment module within a vehicle door in accordance with an aspect of the invention;

FIG. 2 shows a front view of a rail for the window regulator shown in FIG. 1;

FIGS. 3a to 3d show a side view of an adjustable mounting bracket in isolation for the rail shown in FIG. 2;

FIG. 4 shows a side view of the adjustable mounting bracket for the rail shown in FIGS. 3a to 3d pivoting around an instantaneous center (C) and

FIG. 5 shows a side view of an alternate adjustable mounting bracket pivoting around a different instantaneous center (C′).

### DETAILED DESCRIPTION OF THE INVENTION

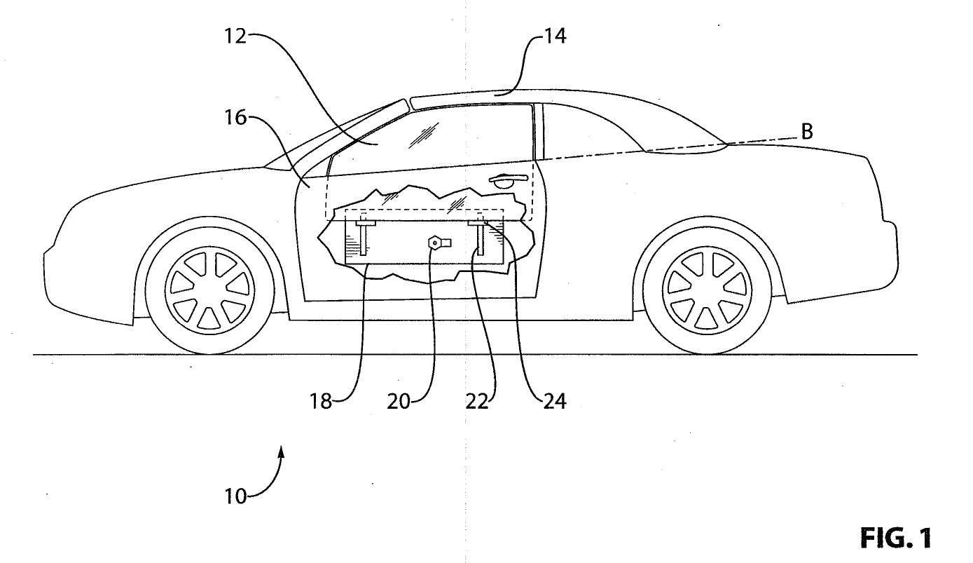

FIG. 1 shows a vehicle 10 (a convertible) having a movable closure panel such as window glass 12 and a retractable roof 14. Window glass 12 is slidably retained within a frameless door 16 (i.e., the side and upper edges of window glass 12 are not surrounded by door 16 when in the raised position), and is movable between a raised position substantially outside of door 16 and a lowered position that is substantially within door 16. Door 16 is formed using spaced outer and inner sheet metal panels that provide storage for window glass 12 when it is in the lowered position. An equipment module 18 is located within an aperture in the inner sheet metal panel. Since all of its edges are surrounded by the door frame, equipment module 18 ends at a height several inches below the belt line (as indicated by the letter ‘B’) of door 16. Equipment module 18 is preferably manufactured from a composite material, and includes a plurality of pre-molded and pre-mounted components to reduce door assembly time and costs.

Window glass 12 is raised or lowered by a window regulator 20 that is mounted to equipment module 18. Preferably, window regulator 20 is a powered window regulator, driven by a reversible electric motor, but manually winched window regulators are within the scope of the invention. Window seals (not shown) are provided at the upper edge of door 16 at the belt line on opposite sides of window glass 12 to provide an environmental seal for the interior of door 16. Window regulator 20 includes a pair of spaced rails 22 are mounted to the wetside (i.e., facing towards the exterior of the vehicle) of equipment module 18 in parallel. Each rail 22 is adapted to slidably retain a lifter plate 24 that raises or lowers window glass 12.

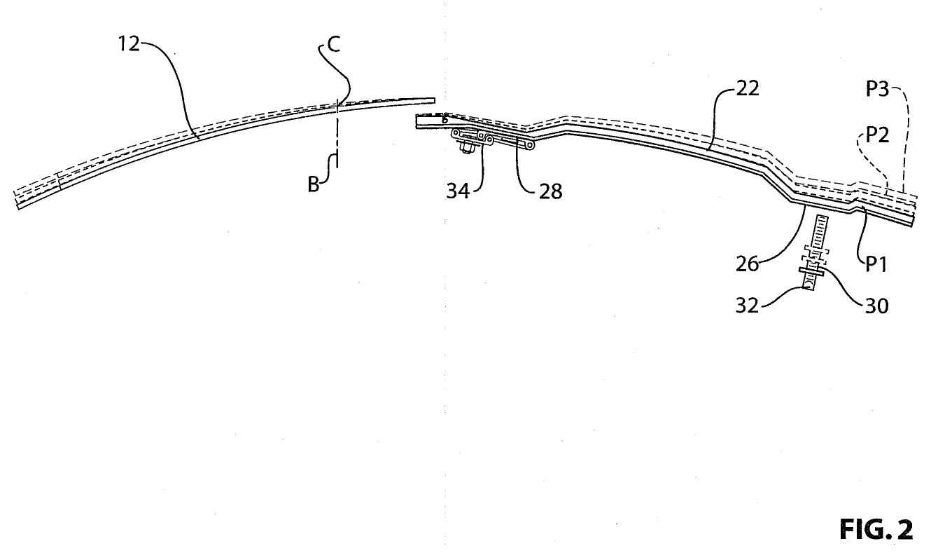

Referring now to FIG. 2, one of the two rails 22 is shown in greater detail. Equipment module 18 and lifter plate 24 have been omitted for the purposes of clarity. P1, P2 and P3 indicate different possible positions of rail 22 relative to equipment module 18 (FIG. 1). Rail 22 is slightly bowed to provide an arcuate path for window glass 12 that is complementary to the curvature of door 16. Rail 22 includes a lower mounting surface 26 and an upper mounting surface 28 that are adapted to assist in mounting the rail to equipment module 18. A jackscrew 30 extends through aligned apertures (not shown) in both equipment module 18 and the lower mounting surface 26 on each rail 22 to secure the rail's lower end. By adjusting the head 32 of jackscrew 30, the lower end of rail 22 is displaced away from or towards equipment module 18 linearly. As indicated by FIG. 2, P1 shows rail 22 adjacent to equipment module 18, and P3 shows rail 22 displaced to the maximum distance from equipment module 18. The head 32 of jackscrew 26 is presented on the dryside of equipment module 18 (i.e., towards the interior of the vehicle) and is typically accessible for adjustment on an assembled door 16, typically hidden by a trim panel (not shown). By twisting head 32 clockwise or counterclockwise, an assembler can easily adjust the displacement of lower mounting surface 26 relative to equipment module 18.

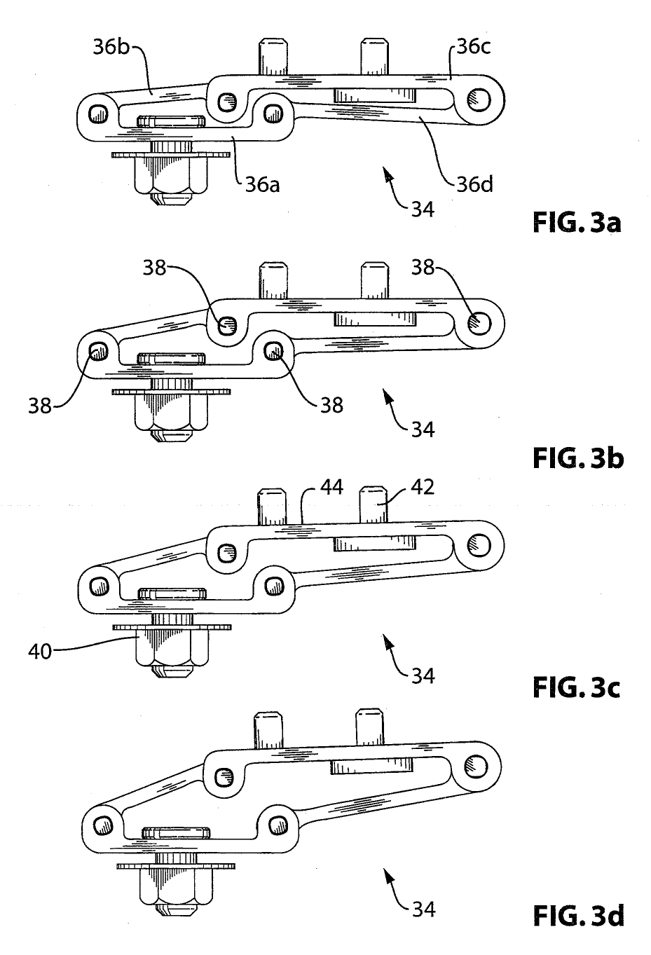

An adjustable mounting bracket 34 secures rail 22's upper mounting surface 28 to equipment module 18. Mounting bracket 34 comprises four bar segments 36a, 36b, 36c and 36d that are pivotally connected to each other using pins 38 that are disposed in a parallelogram relationship (FIG. 3a-3d). A conventional fastener 40 (such as a nut and bolt) extends through aligned apertures (not shown) in both equipment module 18 and bar segment 36a, and a separate fastener 42 extends through aligned apertures in upper mounting surface 28 and bar segment 36c. A mounting surface 44 is also provided on bar segment 36c to attach lifter plate 24.

Cross-car adjustment is performed by moving the lower end of each rail 22 closer or further from the equipment module 18 using jack screw 30. By adjusting the distance of lower mounting surface 26 closer to or away from the equipment module 18, mounting bracket 34 pivots in place, collapsing inwards or expanding outwards. When rail 22 is located adjacent to equipment module 18 (as indicated by P1 in FIG. 2), the bar segments 36 of mounting bracket 34 are collapsed (as indicated by FIG. 3a). When the base end of rail 22 is located away from equipment module 18 (as indicated by P3 in FIG. 2), the bar segments 36 are unfolded (as indicated by FIG. 3d). Since jackscrew 30 retains lower mounting surface 26 at a fixed distance away from equipment module 18 and rail 22 is relatively rigid, bar segments 36 remain in place (i.e., the parallelogram does not collapse or expand) Those of skill in the art will recognize that the positions indicated are merely exemplary and that rail 22 can be positioned between P1, P2 and P3

As adjustable bracket 34 is fixed to both equipment module 18 and rail 22, the expansion of bar segments 36 causes rail 22 and the slidably mounted window glass 12 to pivot around an instantaneous center (indicated by the letter ‘C’ in FIG. 2) that is located between the two seals at the belt line (indicated by the letter ‘B’ in FIG. 2). Thus, friction on the belt seals is minimized, regardless of the cross-car adjustment. The upper edge of window glass 12 now correctly aligns with the seals provided on retractable roof 14.

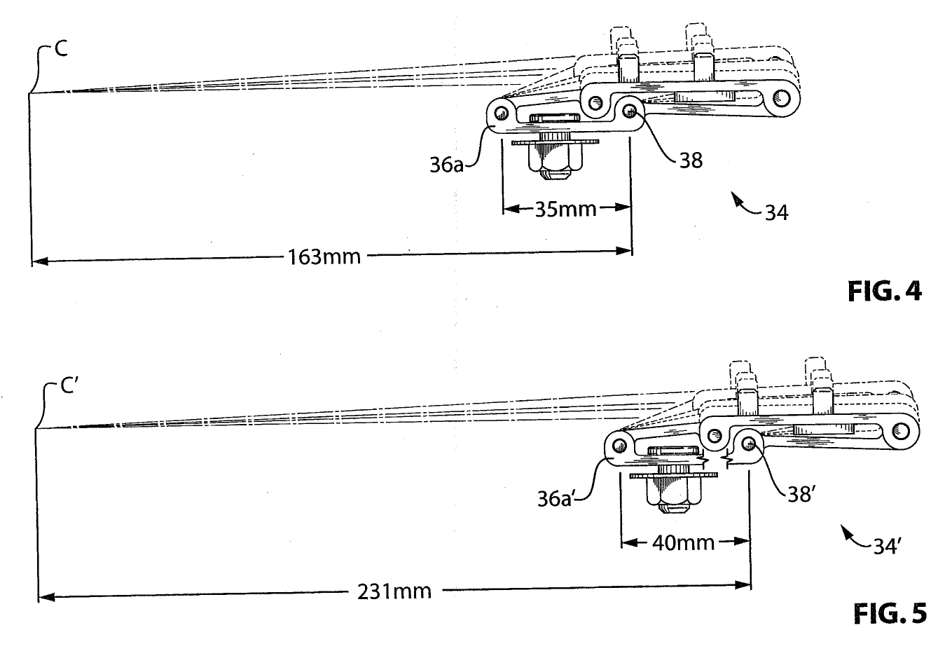

Furthermore, the instantaneous center can be located at a distance away from fastener 40, beyond the edge of equipment module 18. Thus, the pivot point is not limited by the size of the equipment module 18 or the length of the rail 22. Referring now to FIGS. 4 and 5, adjustable brackets 34 with different lengths of bar segments 36 are shown. In FIG. 4, bar segment 36a has a length of 35 mm. The instantaneous center (C′) is located 163 mm away from pin 38a. In FIG. 5, bar segment 36a′ has a length of 40 mm. The instantaneous center (C′) is located 213 mm away from pin 38′. Thus, a change of only 5 mm in the length of bar segment 36a has extended the center of rotation by 68 mm. Persons of skill in the art will recognize that these distances are merely exemplary and that other lengths of bar segments 36 and distances of rotation are within the scope of the invention.

What is claimed is:

1. A window regulator for moving a closure panel between a first and a second position in a door for a vehicle, the window regulator comprising:
at least one rail;
a lift plate slidably mounted to the at least one rail and operable to retain the closure panel;
an adjustable mounting structure operable to pivotally attach the at least one rail to a surface in the door so that the closure panel is operable to pivot around a fixed instantaneous center that is displaced away from the at least one rail.

2. The window regulator of claim 1, wherein the adjustable mounting structure includes:
a first fastener mounted to both a first end of the at least one rail and the vehicle door and operable to linearly displace the first end way from the surface in the door; and
a second fastener mounted to both a second end of the at least one rail and the vehicle door and operable to elliptically displace the second end away from the surface of in the door.

3. The window regulator of claim 2, wherein the instantaneous center is located between a pair of seals for the closure panel.

4. The window regulator of claim 3, wherein the second fastener comprises a plurality of bar segments that are pivotally connected in a parallelogram configuration.

5. The window regulator of claim 4, wherein the first fastener is adjustable on the side of the door opposite the side that the at least one rail is mounted to.

6. The window regulator of claim 5, wherein the first fastener is adjustable even after the door is mounted to the vehicle.

7. The window regulator of claim 1, wherein the surface of the door that is attached to the window regulator is an equipment module that can be pre-assembled prior to mounting to the door.
